(19) United States
(12) Patent Application Publication
(10) Pub. No.: US 2002/0131522 A1
(43) Pub. Date: Sep. 19, 2002

(54) Method and apparatus for the digital predistortion linearization, frequency response compensation linearization and feedforward linearization of a transmit signal

(76) Inventor: Tilman Felgentreff, Holzkirchen (DE)

Correspondence Address: BELL, BOYD & LLOYD, LLC, P. O. BOX 1135, CHICAGO, IL, 60690-1135, US

(21) Appl. No.: 09/997,923

(22) Filed: Nov. 29, 2001

(30) Foreign Application Priority Data
Mar. 14, 2001 (DE) 101 12 300.0
Mar. 14, 2001 (EP) 01106256.9

(51) Int. Cl. H04L 25/03

(52) U.S. Cl. 375/296

(57) ABSTRACT

In order to linearize a digital signal, two different signals are fed into the correction loop of a feedforward amplifier. One of the signals (main signal) is subjected to predistortion and frequency response compensation before it is fed to a nonlinear amplifier. A second signal remains undistorted and serves as a reference signal which is used for the compensation of the main signal component. These two signals are fed into the correction loop in order to output a highly linearized output signal.

### BACKGROUND OF THE INVENTION

The present invention relates to a method for linearizing a digitally generated transmit signal with combined digital predistortion linearization and frequency response compensation linearization, feedforward linearization.

The present invention also relates to an apparatus via which the method according to the present invention can be carried out.

Known modulation methods with an amplitude modulation component generate, on the nonlinear components of a transmit signal, disruptive signal components such as spectral widening of the frequencies of the transmit signal and the generation of fault signals, for example.

“High Linearity RF Amplifier Design”, Artech House, ISBN 1-58053-143-1 by P. B. Kerington discloses, for example, methods for linearizing digital signals, in particular digital signals such as occur in the transmitters in the stations of a digital mobile radio network. These are, in particular, what are referred to as feedback, feedforward and predistortion methods, for example. Furthermore, what are referred to as linear amplifiers, which are operated with backoff in what is referred to as class A mode, are known from this prior art. However, these known linear amplifiers generally have an excessively low level of efficiency.

The methods known from this prior art, in particular the feedforward (FF) method, have found widespread application. The feedforward method is applied, for example, in what are referred to as multicarrier power amplifiers for the UMTS Standard (cf. ETSI Standard ETSI/3088 at www.etsi.org).

The feedforward method demands a large amount of expenditure on circuitry but has the advantage of also linearizing time dependent distortions. In order to be able to implement, for example, multicarrier power amplifiers which fulfill the GSM specification (cf GSM Standard 05.05), more than a single feedforward loop (forward correction loop) is necessary for linearizing a transmit signal. However, with each additional feedforward loop, the efficiency of the amplifier drops and the costs increase. For this reason, the method for connecting a number of feedforward loops in series, known from “High Linearity RF Amplifier Design”, is not desirable in practice.

In contrast, linearization via digital predistortion can be implemented very cost effectively if digital circuits which are integrated on an application specific basis, what are referred to as ASICs, are used. Such a method is also disclosed, for example, in “High Linearity RF Amplifier Design”. However, this procedure alone is not yet sufficient to fulfill, for example, the linearization requirements of the GSM Standard.

Particularly in digital mobile radio networks, modem modulation methods with their high peak to mean values during modulation are resulting in even greater requirements in terms of highly linearized signals, and the linearization is to be carried out as cost effectively as possible. In particular, in multicarrier mode, very stringent requirements come to be made of the linearity of the transmitting amplifiers in practice. These requirements cannot be fulfilled satisfactorily by the methods explained above.

An object of the present invention is, therefore, to provide a method for linearizing a digital signal of a transmitter, in particular of a transmitter in a base station or a mobile station of a digital mobile radio network, with which the disadvantages of the prior art can be overcome.

### SUMMARY OF THE INVENTION

Accordingly, in an embodiment of the present invention, a method is provided for linearizing a digitally generated transmit signal, in a transmitter located in a station in a digital mobile radio network, wherein the method includes the steps of: performing digital predistortion and frequency response compensation of the digitally generated transmit signal; performing digital/analog conversion of the predistorted digitally generated signal in order to generate an analog predistorted and frequency response compensated signal from the digitally generated transmit signal; generating an analog phase adapted and amplitude adapted reference signal from the digitally generated signal; generating a fault signal by subtracting the analog predistorted and frequency response compensated signal and the analog phase adapted and amplitude adapted reference signal from one another; and superimposing the analog predistorted and frequency response compensated signal on the fault signal to form an output signal, wherein a numeric variation of the analog predistorted and frequency response compensated signal and phase adaptation and amplitude adaptation of the reference signal are carried out by logically feeding back measurement variables, which evaluate at least one of the fault signal and the output signal, to the analog predistorted and frequency response compensated signal and to the phase adapted and amplitude adapted reference signal.

In an embodiment, the method further includes the steps of: performing adaptation of the phase and the amplitude of the power minimized fault signal; and combining the phase adapted and amplitude adapted fault signal with the analog predistorted and frequency response compensated signal, which is delayed, to form a linearized output signal.

In an embodiment, the method further includes the step of amplifying the analog predistorted and frequency response compensated signal before the step of generating the fault signal.

In an embodiment, the method further includes the step of amplifying the phase adapted and amplitude adapted fault signal before the step of combining the phase adapted and amplitude adapted fault signal with the delayed analog predistorted and frequency response compensated signal.

In an embodiment, the method further includes the step of performing digital upmixing of the digitally generated transmit signal, wherein the step of performing digital/analog conversion includes performing digital/analog conversion of the upmixed predistorted digitally generated transmit signal.

In an embodiment, the method further includes the steps of: performing I/Q dual digital/analog conversion of the digitally predistorted digitally generated transmit signal; and performing I/Q modulation of the I/Q dual digital/analog converted digitally predistorted digitally generated transmit signal.

In an embodiment, the generation of a reference signal from the digitally generated transmit signal includes the steps of: performing adaptation of the phase and the amplitude of the digitally generated transmit signal; performing digital upmixing of the phase adapted and amplitude adapted digitally generated transmit signal; and performing digital/analog conversion of the upmixed predistorted digitally generated transmit signal.

In an embodiment, the generation of a reference signal from the digitally generated transmit signal includes the steps of: performing adaptation of the phase and the amplitude of the digitally generated transmit signal; performing I/Q dual digital/analog conversion of the digitally predistorted digitally generated transmit signal; and performing I/Q modulation of the I/Q dual digital/analog converted digitally predistorted digitally generated transmit signal, the I/Q modulated I/Q dual digital/analog converted digitally predistorted digital modulated input signal being frequency compensated with the I/Q modulated I/Q dual digital/analog converted digitally predistorted digital transmit signal.

In a further embodiment of the present invention, an apparatus is provided for linearizing a digitally generated transmit signal, in a transmitter, for use in a station in a digital mobile radio network, the apparatus including: a first signal processing path having a digital predistortion unit into which the digitally generated transmit signal is fed and digitally predistorted, on the first signal processing path an analog predistorted and frequency response compensated signal which is derived from the digitally generated transmit signal is transmitted into a nonlinear main amplifier; a second signal processing path on which an analog reference signal which is derived from the digitally generated transmit signal is transmitted; a part for combining the analog predistorted and frequency response compensated signal and the analog reference signal to form a fault signal, and for feeding the fault signal into the second signal processing path; a part in a predistortion and frequency response compensation signal generation path and a part in a reference signal generation path for varying the predistortion of the analog predistorted and frequency response compensated signal and the phase and the amplitude of the reference signal; a second amplifier in the second signal processing path for amplifying at least one of the phase varied fault signal and the amplitude varied signal; a part which combines an output signal of the second amplifier in the second signal processing path with the analog predistorted and frequency response compensated signal in the first signal processing path to form a further output signal; a correction loop which includes the part for combining the analog predistorted and frequency response compensated signal and the analog reference signal, the second amplifier and the part which combines an output signal of the second amplifier with the analog predistorted and frequency response compensated signal; and a part for logically feeding back measurement variables, which evaluate at least one of the fault signal and the further output signal, to the analog predistorted and frequency response compensated signal and to the phase adapted and amplitude adapted reference signal.

In an embodiment, the apparatus further includes a unit for adapting the phase and amplitude of the fault signal in the second signal processing path.

In an embodiment, the apparatus further includes a first delay unit for delaying the analog predistorted and frequency response compensated signal in the first signal processing path In an embodiment, the apparatus further includes a device for observing the fault signal in the second signal processing path.

In an embodiment, the apparatus further includes a second delay unit for delaying the reference signal, provided in the second signal processing path upstream of the part for combining the analog predistorted and frequency response compensated signal and the analog reference signal.

In an embodiment, the apparatus further includes: a transmitter unit for generating the digitally generated transmit signal; a first signal shaping path for deriving the analog predistorted and frequency response compensated signal from the digitally generated transmit signal, an output of the first signal shaping path leading into a first input line which leads to the nonlinear main amplifier in the first signal processing path; and a second signal shaping path for deriving the analog reference signal from the digitally generated transmit signal received by the transmitter unit; an output of the second signal shaping path leading into a second input line leading to the part for combining the analog predistorted and frequency response compensated signal and the analog reference signal.

In an embodiment, the first signal shaping path includes the digital predistortion unit, a first unit for digitally upmixing the predistorted digital data which is output by the digital predistortion unit, and a first digital/analog converter by which the digital data which is output by the first unit for digital upmixing is converted into the analog predistorted signal; the second signal shaping path includes a second unit for adapting the phase and the amplitude of the digital modulated data signals received by the transmitter unit, a second unit for digitally upmixing the digital data which is output by the second unit for adapting the phase and the amplitude, and a second digital/analog converter by which the digital data which is output by the second unit for digital upmixing is converted into the analog reference signal.

In an embodiment, the first signal shaping path includes a digital predistortion unit, a first unit for the I/Q dual digital/analog conversion of the predistorted and frequency response compensated digital data which is output by the digital predistortion unit, and a first I/Q modulator for modulating the signal, which is output by the first unit for the I/Q dual digital/analog conversion, into the analog predistorted and frequency response compensated signal; the second signal shaping path includes a second unit for adapting the phase and the amplitude of a digitally generated signal received by the transmitter unit, a second unit for the I/Q dual digital/analog conversion of the predistorted and frequency response compensated digital data which is output by the second unit for adapting the phase and the amplitude, and a second I/Q modulator for modulating the signal, which is output by the second unit for the I/Q dual digital/analog conversion, into the analog reference signal; and the first I/Q modulator and the second I/Q modulator are connected via a connecting line into which signals of a local oscillator circuit unit are fed.

Additional features and advantages of the present invention are described in, and will be apparent from, the following Detailed Description of the Invention and the Figures.

### BRIEF DESCRIPTION OF THE FIGURES

FIG. 1 shows a block circuit diagram of an assembly for the combined execution, according to the present invention, of digital predistortion linearization, frequency response compensation linearization and feedforward linearization.

FIG. 2 shows a block circuit diagram of an assembly which uses digital upmixers for generating a predistorted and frequency response compensated signal and a reference signal such as are fed to the assembly shown in FIG. 1.

FIG. 3 shows a block circuit diagram of an assembly which uses IQ modulators (inphase quadrature phase modulators vector modulators) for generating a predistorted and frequency response compensated signal and a reference signal, such as are fed to the assembly shown in FIG. 1.

### DETAILED DESCRIPTION OF THE INVENTION

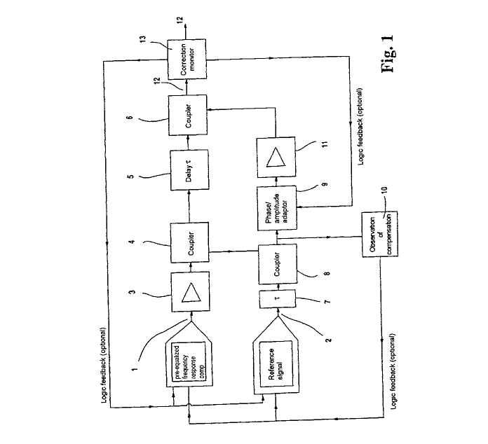

The assembly shown in FIG. 1 includes, at the top of the diagram, a first signal processing chain for generating a predistorted and frequency response compensated signal and, at the bottom of the diagram, a second signal processing chain for generating a reference signal. As stated below, the first and second signal processing chains are coupled to one another in order to form a correction loop for linearizing a digital signal.

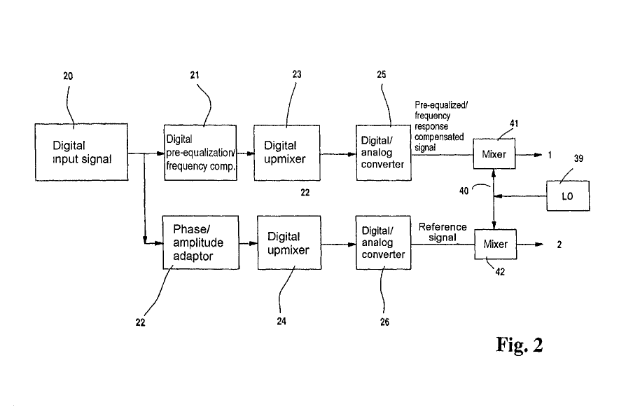

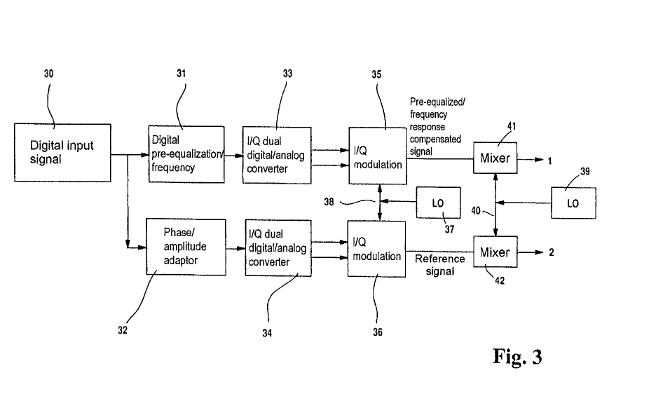

The generation of an analog predistorted and frequency response compensated signal which is received via a first input line 1 in FIG. 1, and the generation of an analog reference signal which is received via a second input line 2 are explained further below in more detail in conjunction with FIGS. 2 and 3.

In the first signal processing chain at the top of the diagram in FIG. 1, an analog predistorted and frequency response compensated signal which is received by a first connecting line 1 is fed to a nonlinear main amplifier 3 and amplified there.

The analog predistorted and frequency response compensated signal which is amplified by the nonlinear main amplifier 3 is forwarded to a first coupler 4. On the one hand, the first coupler 4 passes the amplified analog predistorted and frequency response compensated signal on to a first delay unit 5. On the other hand, the first coupler 4 is connected to a second coupler 8 in the second signal processing chain.

The first delay unit 5 is connected to a third coupler 6. The latter is also connected to the output of an amplifier 11 which is in the lower signal processing chain.

An analog reference signal which is received via the second input line 2 is firstly forwarded to a second optional delay unit 7 in the lower signal processing chain. The reference signal which is output with a delay by the second delay unit 7 is fed to the second coupler 8, where it is combined with the amplified predistorted and frequency response compensated signal fed from the first coupler 4.

The second coupler 8 then transmits the difference between the amplified predistorted and frequency response compensated signal fed in from the first coupler 4 and the delayed reference signal as a compensation signal (fault signal), on the one hand to an optional device 10 for observing the compensation of the two signals and, on the other hand, to a unit 9 for adapting the phase and the amplitude of the fault signal. The unit 9 transmits a phase adapted and amplitude adapted fault signal to a second amplifier 11. This second amplifier 11 has the function of a fault amplifier in the correction loop. A feedback signal (which is referred to as “logic feedback”) is optionally transmitted to the units 21, 22 and 31, 32, respectively (see FIGS. 2 and 3) explained in more detail below by the optional device 10 for observing the compensation of the two signals.

The second amplifier 11 transmits an amplified phase adapted and amplitude adapted fault signal to the third coupler 6.

In the third coupler 6, the delayed amplified predistorted and frequency response compensated signal which originates from the second delay unit 5 in the first signal processing chain and the amplified phase adapted and amplitude adapted fault signal which originates from the second amplifier 11 in the lower signal processing chain are combined; i.e., subtracted from one another. The signal which is combined in the coupler 6 is then highly linearized owing to the subtraction of the fault signal.

The highly linearized signal which results from this subtraction is transmitted by an output line to a correction monitor 13 from where an optional feedback signal (“logic feedback”) to the units 21, 22 and 31, 32, respectively, (see FIGS. 2 and 3) explained in more detail below, is fed back. From the correction monitor 13, the highly linearized signal is passed on to a transmitter antenna (not shown) via the output line.

The arrangement which includes first coupler 4, first delay unit 5, third coupler 6, second coupler 8, unit 9 for adapting the phase and the amplitude of the fault signal and fault amplifier 11 forms a forward correction loop for a feedforward amplifier.

FIG. 2 shows the block circuit diagram of an assembly for generating a predistorted and frequency response compensated signal and a reference signal in accordance with a first embodiment, to generate which digital upmixers are used.

In the assembly shown in FIG. 2, digital modulated data (even for a number of carrier frequencies) which is received in a digital transmitter unit 20, as used, for example, in a base station or a mobile station in a digital mobile radio network, is fed into a predistortion and frequency response compensation signal generating chain at the top in FIG. 2 and into a reference signal generating chain at the bottom in FIG. 2.

In the predistortion and frequency response compensation signal generating chain, the digital modulated data coming from the digital transmitter unit 20 first passes into a unit 21 for predistortion and frequency response compensation. There, the parameterized digital data is manipulated, that is to say “numerically distorted”, by numerical manipulation of the parameters. The data which is distorted in this way is represented, for example, by numerically selected predistortion coefficients. The digital predistortion and the frequency response compensation have the objective of compensating the nonlinearity of the main amplifier 3 in the sense that the power of the fault signal is minimized downstream of the coupler 8. In the frequency response compensation, in particular the nonlinearity of the main amplifier 3, is compensated during the frequency specific outputting of power.

The unit 21 for predistortion and frequency response compensation transmits predistorted and frequency response compensated digital modulated signals into an optional first unit 23 for digital (frequency) upmixing. From there, upmixed predistorted and frequency response compensated digital modulated data is transmitted into a first digital/analog converter 25. The latter then transmits analog upmixed predistorted and frequency response compensated signals to the nonlinear main amplifier 3 (shown in FIG. 1) via the first input line 1.

In the reference signal chain shown at the bottom in FIG. 2, the digital modulated data (even for a number of carrier frequencies) fed in by the transmitter unit 20 is transmitted to a unit 22 for adapting the phase and the amplitude. From there, phase adapted and amplitude adapted digital modulated data is transmitted to an optional second unit 24 for digital (frequency) upmixing. The latter transmits (frequency) upmixed phase adapted and amplitude adapted digital modulated data to a second digital/analog converter 26. The latter then transmits an analog reference signal to the optional second delay unit 7 (shown in FIG. 1) via the second input line 2.

In FIG. 2, the first and second units 23, 24 for digital upmixing are optional and are used to convert the frequency of the input signal into an intermediate frequency position.

FIG. 3 shows, for a second embodiment, the block circuit diagram of an assembly in which I/Q modulators (vector modulators) are used in order to generate a predistorted and frequency response compensated signal and a reference signal which are fed for further processing into the assembly for carrying out the method according to the present invention (shown in FIG. 1).

In FIG. 3, digital modulated data which is received from a transmitter unit 30 such as is used, for example, in a base station or a mobile station in a digital mobile radio network, is fed into a predistortion and frequency response compensation signal generating chain, shown at the top in FIG. 3, and into a reference signal generating chain, shown at the bottom in FIG. 3.

In the predistortion and frequency response compensation signal generating chain, the digital modulated data which comes from the transmitter unit 30 first passes into a unit 31 for digital predistortion and frequency response compensation. Here, too, a “numerical predistortion” and frequency response compensation take place. The unit 31 transmits predistorted and frequency response compensated digital modulated data into a first unit 33 for I/Q dual D/A conversion. From there, analog converted data is transmitted into an I/Q modulator 35.

In the reference signal generating chain shown in FIG. 3, the digital modulated data fed in by the transmitter unit 30 is transmitted to a unit 32 for adapting the phase and the amplitude. From there, phase adapted and amplitude adapted digital modulated data is transmitted to a second unit 34 for I/Q dual D/A conversion. The second unit 34 for I/Q dual D/A conversion feeds analog converted data to a second I/Q modulator 36.

The first I/Q modulator 35 and the second I/Q modulator 36 are connected to one another via an optional first connecting line 38. Signals are fed into the first connecting line 38 by an optional LO (local oscillator) unit 37. As a result, a frequency conversion of the signals coming from the I/Q dual digital/analog converters 33, 34 can take place. The first connecting line is used to distribute in phase the signal fed in by the LO unit 37.

An analog predistorted and frequency response compensated signal is then transmitted from the predistortion and frequency response compensation signal generating chain to the nonlinear main amplifier 3 shown in FIG. 1, via the first input line 1.

An analog reference signal is then transmitted from the reference signal generating chain to the second delay unit 7 (shown in FIG. 1) via a second input line 2.

According to the present invention, a method for linearizing an input signal via feedforward is combined with a method for digital predistortion and frequency response compensation. This results in a very high linearization effect with a relatively low level of expenditure on circuitry.

According to the present invention, two different signals, namely a digitally predistorted and frequency response compensated signal and a nondistorted reference signal are combined in the correction loop of a feedforward amplifier. The reference signal is used to compensate the predistorted signal in the correction loop.

The necessary adaptive setting of the phase and the amplitude of the predistorted and frequency response compensated signal and of the reference signal for optimum suppression of the signal component in the fault amplifier 11 is carried out via feedback (“logic feedback”).

As is apparent from FIG. 1, an optional logic feedback takes place from the correction monitor 13 in the output line 12 to the predistortion and frequency response compensation signal generating chain (to be more precise, to the units 21 and 31 located there) and to the reference signal generating chain (to be more precise, to the units 22 and 32 located there) and/or an optional logic feedback from the correction monitor 13 to the unit 9 in order to adapt the phase and amplitude of the fault signal in the correction loop and/or an optional logic feedback from the device 10 for the observation of the compensation signal to the predistortion and frequency response compensation signal generating chain (to be more precise, to the units 21 and 31 located there) and to the reference signal generating chain (to be more precise, to the units 22 and 32 located there).

Such instances of logic feedback adjust the phase and the amplitude of the reference signal and the predistortion coefficients and/or the frequency response compensation of the signal transmitted to the main amplifier 3 via the input line 1 in such a way that, for example, a minimum level of power is measured downstream of the second coupler 8 by the unit 10 for monitoring the compensation in the correction loop.

It is important that at least one of the three logic feedback loops shown in FIG. 1 is embodied, optionally two or all three logic feedback loops can be combined with one another in order to increase the stabilization of the feedback.

The second coupler 8 feeds what is referred to as the fault amplifier 11 in the correction loop. The further adaptation of the phase and amplitude of the fault signal in the unit 9 is used to set the correction signal precisely with respect to the signal of the main amplifier, and in particular also to compensate a temperature drift and to compensate the frequency response of the fault amplifier 11.

The correction loop has the same effect as in a conventional feedforward amplifier.

The separate generation of the predistorted and frequency response compensated signal has the further advantage that pilot tones (fault signals with a small amplitude which are intentionally introduced into the digital input signals), which may be required for the adaptive adjustment of the phase and the amplitude of the fault signal, also can be generated digitally without additional expenditure on circuitry. The setting of the phase and amplitude (or I/Q setting) in the correction loop is selected in such a way that maximum suppression of the fault signals (=correction signals) which are phase shifted by 180° and amplified in the correction loop is achieved. This is carried out via the unit 9. The reference signal and the predistorted and frequency response compensated signal can be generated at a limit frequency position or at an intermediate frequency which still has to be converted to the limit frequency.

There are various ways of generating the reference signal and the predistorted signal, as explained in conjunction with FIGS. 2 and 3. The analog I/Q modulators shown in FIG. 3 act here on a limit frequency or an intermediate frequency. An intermediate frequency is generated by an optional first local oscillator 37 and/or an optional second local oscillator 39. The intermediate frequency generated by the optional second local oscillator 39 is added to the predistorted and frequency response compensated signal or the reference signal via a second connecting line 40 and, in each case, a mixer 41 or 42, respectively. As a result, frequency conversion of the I/Q modulated I/Q dual digital/analog converted digitally predistorted input signal with the I/Q modulated I/Q dual digital/analog converted digitally predistorted signal is carried out.

Depending on the selected method of generation, a difference in delay which still may occur and which restricts the linearization bandwidth must be compensated by inserting an additional delay unit downstream of the reference signal generation. The optional second delay unit 7 shown in FIG. 1 is used for this.

An advantage of the solution according to the present invention is that it combines two efficient linearization methods and, thus, achieves a very high linearization effect.

At the same time, the present invention can be implemented with novel, highly integrated converter concepts which operate, for example, directly in the limit frequency position.

This makes it possible to operate with a solution which is significantly more cost effective than the insertion of a second feedforward loop and enables a high level of linearization to be achieved in comparison with exclusively adaptive predistortion at the limit frequency position.

Indeed, although the present invention has been described with references to specific embodiments, those of skill in the art will recognize that changes may be made thereto without departing from the spirit and scope of the invention as set forth in the hereafter appended claims.

1. A method for linearizing a digitally generated transmit signal, in a transmitter located in a station in a digital mobile radio network, the method comprising the steps of:
performing digital predistortion and frequency response compensation of the digitally generated transmit signal;
performing digital/analog conversion of the predistorted digitally generated signal in order to generate an analog predistorted and frequency response compensated signal from the digitally generated transmit signal;
generating an analog phase adapted and amplitude adapted reference signal from the digitally generated signal;
generating a fault signal by subtracting the analog predistorted and frequency response compensated signal and the analog phase adapted and amplitude adapted reference signal from one another; and
superimposing the analog predistorted and frequency response compensated signal on the fault signal to form an output signal, wherein a numeric variation of the analog predistorted and frequency response compensated signal and phase adaptation and amplitude adaptation of the reference signal are carried out by logically feeding back measurement variables, which evaluate at least one of the fault signal and the output signal, to the analog predistorted and frequency response compensated signal and to the phase adapted and amplitude adapted reference signal.

2. A method for linearizing a digitally generated transmit signal as claimed in claim 1, the method further comprising the steps of:
performing adaptation of the phase and the amplitude of the power minimized fault signal; and
combining the phase adapted and amplitude adapted fault signal with the analog predistorted and frequency response compensated signal, which is delayed, to form a linearized output signal.

3. A method for linearizing a digitally generated transmit signal as claimed in claim 1, the method further comprising the step of:
amplifying the analog predistorted and frequency response compensated signal before the step of generating the fault signal.

4. A method for linearizing a digitally generated transmit signal as claimed in claim 2, the method further comprising the step of:
amplifying the phase adapted and amplitude adapted fault signal before the step of combining the phase adapted and amplitude adapted fault signal with the delayed analog predistorted and frequency response compensated signal.

5. A method for linearizing a digitally generated transmit signal as claimed in claim 1, the method further comprising the step of:
performing digital upmixing of the digitally generated transmit signal, wherein the step of performing digital/analog conversion includes performing digital/analog conversion of the upmixed predistorted digitally generated transmit signal.

6. A method for linearizing a digitally generated transmit signal as claimed in claim 1, the method further comprising the steps of:
performing I/Q dual digital/analog conversion of the digitally predistorted digitally generated transmit signal; and
performing I/Q modulation of the I/Q dual digital/analog converted digitally predistorted digitally generated transmit signal.

7. A method for linearizing a digitally generated transmit signal as claimed in claim 1, wherein generation of a reference signal from the digitally generated transmit signal comprises the steps of:
performing adaptation of the phase and the amplitude of the digitally generated transmit signal;
performing digital upmixing of the phase adapted and amplitude adapted digitally generated transmit signal; and
performing digital/analog conversion of the upmixed predistorted digitally generated transmit signal.

8. A method for linearizing a digitally generated transmit signal as claimed in claim 1, wherein generation of a reference signal from the digitally generated transmit signal comprises the steps of:
performing adaptation of the phase and the amplitude of the digitally generated transmit signal;
performing I/Q dual digital/analog conversion of the digitally predistorted digitally generated transmit signal; and
performing I/Q modulation of the I/Q dual digital/analog converted digitally predistorted digitally generated transmit signal, the I/Q modulated I/Q dual digital/analog converted digitally predistorted digital modulated input signal being frequency compensated with the I/Q modulated I/Q dual digital/analog converted digitally predistorted digital transmit signal.

9. An apparatus for linearizing a digitally generated transmit signal, in a transmitter, for use in a station in a digital mobile radio network, comprising:
a first signal processing path having a digital predistortion unit into which the digitally generated transmit signal is fed and digitally predistorted, on the first signal processing path an analog predistorted and frequency response compensated signal which is derived from the digitally generated transmit signal is transmitted into a nonlinear main amplifier;
a second signal processing path on which an analog reference signal which is derived from the digitally generated transmit signal is transmitted;
a part for combining the analog predistorted and frequency response compensated signal and the analog reference signal to form a fault signal, and for feeding the fault signal into the second signal processing path;
a part in a predistortion and frequency response compensation signal generation path and a part in a reference signal generation path for varying the predistortion of the analog predistorted and frequency response compensated signal and the phase and the amplitude of the reference signal;
a second amplifier in the second signal processing path for amplifying at least one of the phase varied fault signal and the amplitude varied signal;
a part which combines an output signal of the second amplifier in the second signal processing path with the analog predistorted and frequency response compensated signal in the first signal processing path to form a further output signal;
a correction loop which includes the part for combining the analog predistorted and frequency response compensated signal and the analog reference signal, the second amplifier and the part which combines an output signal of the second amplifier with the analog predistorted and frequency response compensated signal; and
a part for logically feeding back measurement variables, which evaluate at least one of the fault signal and the further output signal, to the analog predistorted and frequency response compensated signal and to the phase adapted and amplitude adapted reference signal.

10. An apparatus for linearizing a digitally generated transmit signal as claimed in claim 9, further comprising:
a unit for adapting the phase and amplitude of the fault signal in the second signal processing path.

11. An apparatus for linearizing a digitally generated transmit signal as claimed in claim 9, further comprising:
a first delay unit for delaying the analog predistorted and frequency response compensated signal in the first signal processing path.

12. An apparatus for linearizing a digitally generated transmit signal as claimed in claim 9, further comprising:
a device for observing the fault signal in the second signal processing path.

13. An apparatus for linearizing a digitally generated transmit signal as claimed in claim 9, further comprising:
a second delay unit for delaying the reference signal, provided in the second signal processing path upstream of the part for combining the analog predistorted and frequency response compensated signal and the analog reference signal.

14. An apparatus for linearizing a digitally generated transmit signal as claimed in claim 9, further comprising:
a transmitter unit for generating the digitally generated transmit signal;
a first signal shaping path for deriving the analog predistorted and frequency response compensated signal from the digitally generated transmit signal, an output of the first signal shaping path leading into a first input line which leads to the nonlinear main amplifier in the first signal processing path; and
a second signal shaping path for deriving the analog reference signal from the digitally generated transmit signal received by the transmitter unit; an output of the second signal shaping path leading into a second input line leading to the part for combining the analog predistorted and frequency response compensated signal and the analog reference signal.

15. An apparatus for linearizing a digitally generated transmit signal as claimed in claim 14, wherein:
the first signal shaping path includes the digital predistortion unit, a first unit for digitally upmixing the predistorted digital data which is output by the digital predistortion unit, and a first digital/analog converter by which the digital data which is output by the first unit for digital upmixing is converted into the analog predistorted signal; and
the second signal shaping path includes a second unit for adapting the phase and the amplitude of the digitally generated transmit signal received by the transmitter unit, a second unit for digitally upmixing the digital data which is output by the second unit for adapting the phase and the amplitude, and a second digital/analog converter by which the digital data which is output by the second unit for digital upmixing is converted into the analog reference signal.

16. An apparatus for linearizing a digitally generated transmit signal as claimed in claim 14, wherein:
the first signal shaping path includes a digital predistortion unit, a first unit for the I/Q dual digital/analog conversion of the predistorted and frequency response compensated digital data which is output by the digital predistortion unit, and a first I/Q modulator for modulating the signal, which is output by the first unit for the I/Q dual digital/analog conversion, into the analog predistorted and frequency response compensated signal;
the second signal shaping path includes a second unit for adapting the phase and the amplitude of a digitally generated signal received by the transmitter unit, a second unit for the I/Q dual digital/analog conversion of the predistorted and frequency response compensated digital data which is output by the second unit for adapting the phase and the amplitude, and a second I/Q modulator for modulating the signal, which is output by the second unit for the I/Q dual digital/analog conversion, into the analog reference signal; and
the first I/Q modulator and the second I/Q modulator are connected via a connecting line into which signals of a local oscillator circuit unit are fed.
